(19) United States
(12) Patent Application Publication
(10) Pub. No.: US 2025/0086801 A1
(43) Pub. Date: Mar. 13, 2025

(54) SYSTEM AND METHODS FOR DETECTING ASSAY CONTAINER PERFORMANCE

(71) Applicant: IDEXX Laboratories Inc., Westbrook, ME (US)

(72) Inventors: Oisin Biswas, Portland, ME (US); Kevin Chamberland, Portland, ME (US)

(21) Appl. No.: 18/826,654

(22) Filed: Sep. 6, 2024

Related U.S. Application Data
(60) Provisional application No. 63/581,150, filed on Sep. 7, 2023.

(51) Int. Cl. G06T 7/00

(52) U.S. Cl. CPC G06T 7/0016; G06T 2207/10064; G06T 2207/30072

(57) ABSTRACT

Techniques for determining a failure condition of a well of an assay container using image data are described. In some embodiments, a system receives image data representing a first plurality of wells, each of the first plurality of wells holding a biological sample and one or more particles configured to fluoresce in response to binding with a target entity when present in a respective well, analyzes the image data to determine, for a first plurality of pixels corresponding to a first well of the first plurality of wells, a first pixel intensity value, determines that the first pixel intensity value is greater than a first threshold value, and generates first output data indicating that the first well corresponds to a failure condition in response to determining that the first pixel intensity value is greater than the first threshold value.

### CROSS-REFERENCE TO RELATED APPLICATION

This application claims the benefit under 35 U.S.C. § 119 (e) of U.S. Provisional Patent Application No. 63/581,150, filed Sep. 7, 2023, and entitled SYSTEMS AND METHODS FOR DETECTING ASSAY CONTAINER PERFORMANCE, the entire contents of which is incorporated herein by reference for all purposes.

### FIELD OF THE INVENTION

Aspects of the present disclosure involve systems and methods for detecting assay container performance, which may involve detecting malfunctions or errors with respect to an assay.

### BACKGROUND

Some assays can be assessed by analyzing fluorescence/light emissions represented in an image of the assay container. The presence or lack of fluorescence detected from a well in the image of the container may indicate whether a patient is positive or negative for various pathogens.

### SUMMARY

Some embodiments of the present disclosure describe a computer-implemented method comprising receiving image data representing a first plurality of wells, each of the first plurality of wells holding a biological sample and one or more particles configured to fluoresce in response to binding with a target entity when present in a respective well, analyzing the image data to determine, for a first plurality of pixels corresponding to a first well of the first plurality of wells, a first pixel intensity value, determining that the first pixel intensity value is greater than a first threshold value, and generating first output data indicating that the first well corresponds to a failure condition in response to determining that the first pixel intensity value is greater than the first threshold value.

Some embodiments of the present disclosure describe a system comprising at least one processor and at least one memory including instructions that, when executed by the at least one processor, cause the system to receive image data representing a first plurality of wells, each of the first plurality of wells holding a biological sample and one or more particles configured to fluoresce in response to binding with a target entity when present in a respective well, analyze the image data to determine, for a first plurality of pixels corresponding to a first well of the first plurality of wells, a first pixel intensity value, determine that the first pixel intensity value is more than a first threshold value, and generate first output data indicating that the first well corresponds to a failure condition in response to determining that the first pixel intensity value is more than the first threshold value.

Some embodiments of the present disclosure describe a system comprising a plurality of wells, each of the plurality of wells holding a biological sample and one or more particles configured to fluoresce in response to binding with a target entity when present in a respective well, a reader device configured to capture images of the plurality of wells, and a computing device, where the computing device includes at least one processor, and at least one memory including instructions that, when executed by the at least one processor, cause the computing device to receive, from the reader device, image data representing a plurality of wells, analyze the image data to determine, for a plurality of pixels corresponding to a first well of the plurality of wells, a pixel intensity value, determine that the pixel intensity value is more than a threshold value, and generate output data indicating that the first well corresponds to a failure condition in response to determining that the pixel intensity value is more than the threshold value.

### BRIEF DESCRIPTION OF DRAWINGS

Various aspects and embodiments will be described with reference to the following figures. The figures are not necessarily drawn to scale.

FIG. 1A is a conceptual diagram of a system for analyzing an assay container, according to some embodiments of the present disclosure.

FIG. 1B is a flowchart illustrating a process for analyzing image data of an assay container to determine success and failure conditions for individual wells, according to some embodiments of the present disclosure.

FIG. 2 is a flowchart illustrating a process for determining output data for an end user, according to some embodiments of the present disclosure.

FIG. 3 is a flowchart illustrating a process for determining output data indicating an issue with a washer nozzle, according to some embodiments of the present disclosure.

FIG. 4 is a flowchart illustrating a process for determining output data indicating an issue with a washer equipment, according to some embodiments of the present disclosure.

FIG. 5 is a flowchart illustrating a process for determining output data indicating a user error, according to some embodiments of the present disclosure.

FIG. 6 is a flowchart illustrating a process for determining performance data for multiple assay containers, according to some embodiments of the present disclosure.

FIG. 7 is a flowchart illustrating a process for determining output data indicating an issue with a reader device, according to some embodiments of the present disclosure.

FIG. 8 is a flowchart illustrating a process for determining a maintenance schedule for a washer equipment, according to some embodiments of the present disclosure.

FIG. 9 illustrates an example well image and an example user interface of the system of the present disclosure.

FIG. 10A shows example well images representing failure conditions.

FIG. 10B also shows example well images representing failure conditions.

FIG. 11 is a block diagram conceptually illustrating example components of a device, according to some embodiments of the present disclosure.

FIG. 12 is a block diagram conceptually illustrating example components of a system, according to some embodiments of the present disclosure.

### DETAILED DESCRIPTION

An assay can be used as an analytic tool in laboratory medicine, among other things, for qualitatively assessing and/or quantitatively measuring the presence, amount, or functional activity of a target entity. The measured entity is often called the analyte, the measurand, or the target of the assay. The analyte can be a drug, biochemical substance, chemical element or compound, or cell in an organism or organic sample. In some instances, the analyte can be referred to as a biomarker. An assay may be used to determine whether a biological sample (e.g., blood, fecal matter, urine, fine needle aspirate, etc.) from a subject (e.g., a human, a non-human animal, a pet, etc.) includes a particular analyte.

Some assays may be analyzed utilizing fluorescence (e.g., light emissions). A well of an assay container may include a subject sample (e.g., a biological sample) and one or more particles (e.g., identifiable beads) that can bind with a target analyte when the target analyte is present in the well. In response to binding, the particle(s) may fluoresce, for example when exposed to a particular wavelength of light, such as ultraviolet light. In some embodiments, the particles (e.g., the identifiable beads) are structurally configured to fluoresce in response to binding to specific analytes. For example, a first set of the particles may fluoresce in response to binding to a first analyte (e.g., antigen, biomarker, or the like), while a second set of the particles fluoresce in response to binding to a second analyte (e.g., antigen, biomarker, or the like) that is different from the first analyte. The particles (e.g., the identifiable beads), in embodiments, include one or more identifying features, such as a barcode, color, pattern, shape, or the like such that the first set of particles can be distinguished from the second set of particles. By utilizing different sets of particles in a single well, a single biological sample can be simultaneously tested for multiple analytes. While in the example described above, the particles are described as including two sets of particles, it should be understood that any suitable number of sets of particles can be utilized testing for any suitable number of different analytes. The fluorescence emitted from particles within a well can be detected by analyzing images of the assay container/wells. The presence of fluorescence within a well can indicate that one or more analytes (e.g., a target antigen, a target pathogen, etc.) is present in the well (i.e., a positive result for the one or more analytes), whereas a lack of fluorescence can indicate that a target analyte is not present (i.e., a negative result).

Prior to analysis, a washer equipment may be used to remove (e.g., wash) waste from the wells, where waste may refer to excess dye, reagent or the like. As described above, in embodiments, the one or more particles are structurally configured to react with one or more analytes in a biological sample. In some embodiments, dye, reagent, or the like is added to the mixture of biological sample and the one or more particles. The dye, reagent, or the like, in embodiments, causes positively reacting particles, e.g., particles that have bound to one or more analytes in the biological sample to fluoresce upon exposure to specific wavelengths of energy. In embodiments, the washer equipment is configured to remove excess dye, reagent, or the like, from the wells, such that only positively reacting particles fluoresce upon exposure to the specific wavelengths of energy. In some instances, excess dye, reagent, or the like can fluoresce upon exposure to specific wavelengths of energy, and accordingly, it is desirable to remove excess dye, reagent, or the like from the wells, such that positively reacting particles are distinguishable from excess dye, reagent, or the like.

The washer equipment may include multiple washer nozzles, for example, a washer nozzle for each well of the assay container. In some examples, an assay container may have 96 wells, and a washer equipment may have 96 nozzles. After the assay container is washed, a reader device may be used to capture images of various portions of the assay container. In some examples, the reader device may capture images discrete portions or individual quadrants of the assay container. A computing device may be configured to analyze the captured images to determine which, if any, of the wells fluoresce. Malfunction or other errors can cause presence of light artifacts leading to erroneous fluorescence production, which may promote false positives causing output of incorrect lab results.

In some cases, fluorescence associated with a well may be detected for reasons other than particle(s) binding to a target entity, resulting in a false positive reading. For example, if the washer equipment and/or a particular washer nozzle malfunctions all of the waste may not be removed from the wells. As another example, when setting up the assay (e.g., during pipetting), solution intended to be placed inside the wells may be erroneously applied outside of the wells (e.g., on the rim of the well, solution intended for one well may overflow to a surrounding well, etc.). In these example situations, some wells may fluoresce even if there is no target analyte in the well, resulting in a false positive. False positives can affect a subject, such as via the medical treatment provided to the subject, among other things. In some instances, treatment options can be costly and/or cause undue physical stress, and accordingly, it is desirable to prevent false positives in the assay process.

The present disclosure relates to detecting false positives by analyzing images of an assay container to detect when one or more wells of an assay container are fluorescing due to conditions (e.g., a failure condition) other than the particles in the well binding to a target analyte. Some embodiments of the present disclosure include a computing system configured to analyze image data of an assay container to determine a pixel intensity value corresponding to a well and determine whether the pixel intensity value exceeds a threshold value. If the pixel intensity value exceeds the threshold value, the computing system determines that the well corresponds to a failure condition. If the pixel intensity value is less than the threshold value, the computing system determines that the well corresponds to a success condition (e.g., fluorescing of the well, if any, is based on the particles binding to the target analyte). The threshold value may be customizable and may be defined such that only wells having a certain pixel intensity level (e.g., above a threshold intensity level) in the image are determined to correspond to a failure condition, whereas wells having a lower pixel intensity level may be determined to correspond to fluorescence (if any) from the particles (e.g., identifiable beads) indicating a success condition. If a well is determined to be a failure condition (e.g., a false positive), a user may be notified of the specific well, and the results associated with analysis of the well may not be released to an end-user (e.g., a patient, a representative of a patient, etc.) to prevent reporting of a false positive. In some embodiments, the system may notify a user (e.g., a lab technician) that samples of the particular assay container or the particular well associated with the failure condition should be re-tested. As used herein, a failure condition refers to a well fluorescing due to a reason other than the particles binding to a target, such as a malfunctioning component, a user error, etc. As used herein, a success condition refers to results of a well having not been affected by a malfunctioning component, a user error, etc.

In some embodiments, the computing system is configured to determine a mean pixel intensity value for a well or part of a well based, at least in part, on individual pixel intensity values for the pixels in the image corresponding to the well or part of the well. In some embodiments the mean pixel intensity value for the well or part of the well is compared to the threshold value to determine whether the well or part of the well corresponds to a failure condition or a success condition. Using the mean pixel intensity value can be beneficial for various reasons. For example, the mean pixel intensity value can be used to detect a failure condition of a well when only a part of the well (e.g., a quadrant or a half of the well) fluoresces, resulting in a mean pixel intensity value for the well or part of the well that is greater than the threshold value. As another example, using the mean pixel intensity value across multiple individual pixels associated with a well can provide a better estimation of a well fluorescing due to a failure condition as compared to using intensity values for individual pixels of the well, since an individual pixel or a small set of pixels may fluoresce over the threshold intensity value when the particles bind with the target entity, and using intensity values for individual pixels may be detected as a failure condition when instead it is a true positive result. Some embodiments can use other statistical techniques, such as mode, median, etc., to determine a single (or multiple) pixel intensity-based value for a well that can be compared to a threshold value to detect a failure condition.

In some embodiments, the computing system is configured to determine a type of failure condition or a cause of the failure condition. In an example embodiment, in instances in which an individual well is fluorescing, the computing system determines that the failure condition is due to an issue (e.g., a clog, a malfunction, etc.) of a washer nozzle that is used to wash that individual well. In another example embodiment, if a group of adjacent wells of the assay container are fluorescing, the computing system determines that the failure condition is due to a user error (e.g., solution being overfilled causing overflow from one well to another). In yet another example embodiment, if a rim of a well is fluorescing, the computing system determines that the failure condition is due to a user error (e.g., solution was applied outside of the well on the rim while pipetting). In yet another example embodiment, the computing system determines that there is an issue with the washer equipment or the reader device when multiple assay containers that are processed using the washer equipment and the reader device result in multiple wells with failure conditions.

In some embodiments, the computing system is configured to determine when maintenance on the washer equipment should be performed. For such a determination, in some embodiments, the computing system is configured to monitor assay performance over time and identifies that after a period of time has elapsed, the number of failure conditions (e.g., caused due to washer nozzle clogs) for an assay container increases. The elapsed time (e.g., five days, a week, etc.) may be determined as a timeframe when maintenance on the washer equipment is to be performed (e.g., the washer nozzles are to be cleaned every five days).

Teachings of the present disclosure provide, among other things, a tool of detection that analyzes well/container images for failure conditions. Regardless of the source of the error (e.g., due to an instrument component failure or user error), the system of the present disclosure may detect and notify the user of the need to re-test those samples, and reduce the likelihood of false positive results being reported. Moreover, the threshold value used to determine whether the wells pass or fail may be customizable and can be modified for a variety of use cases.

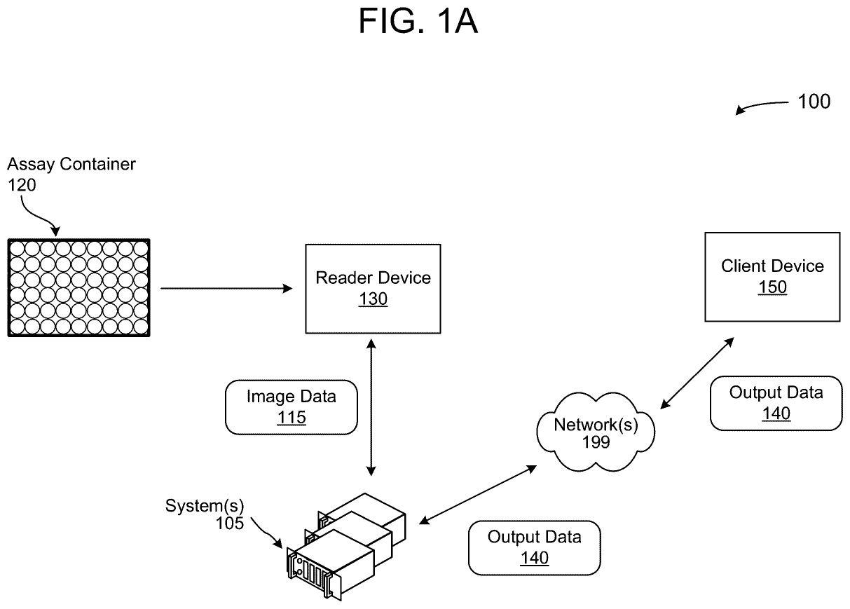

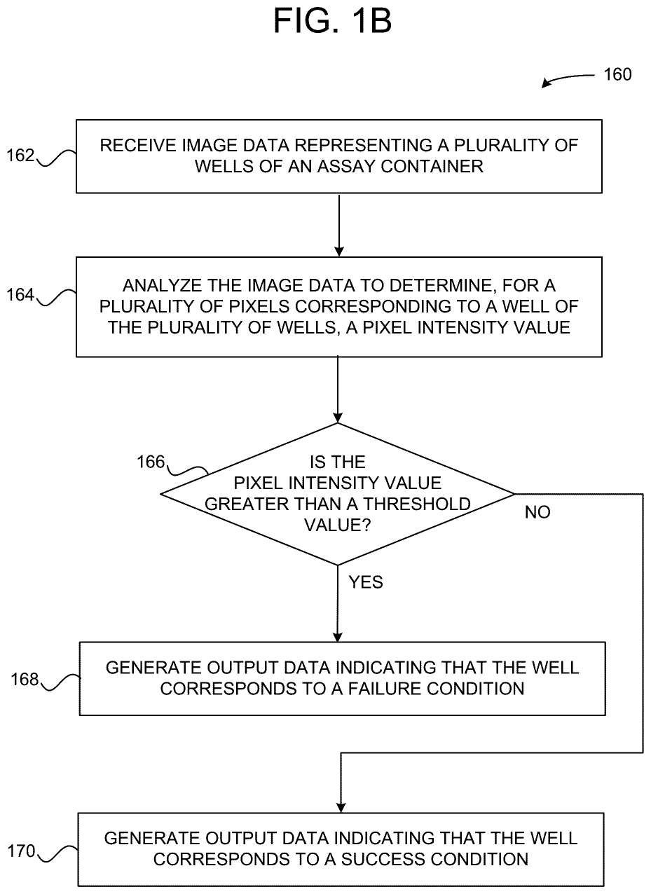

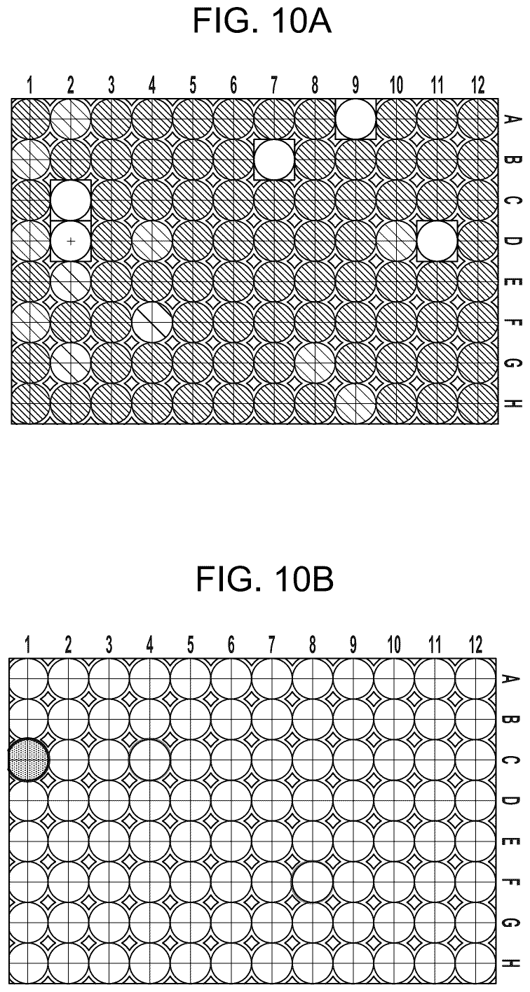

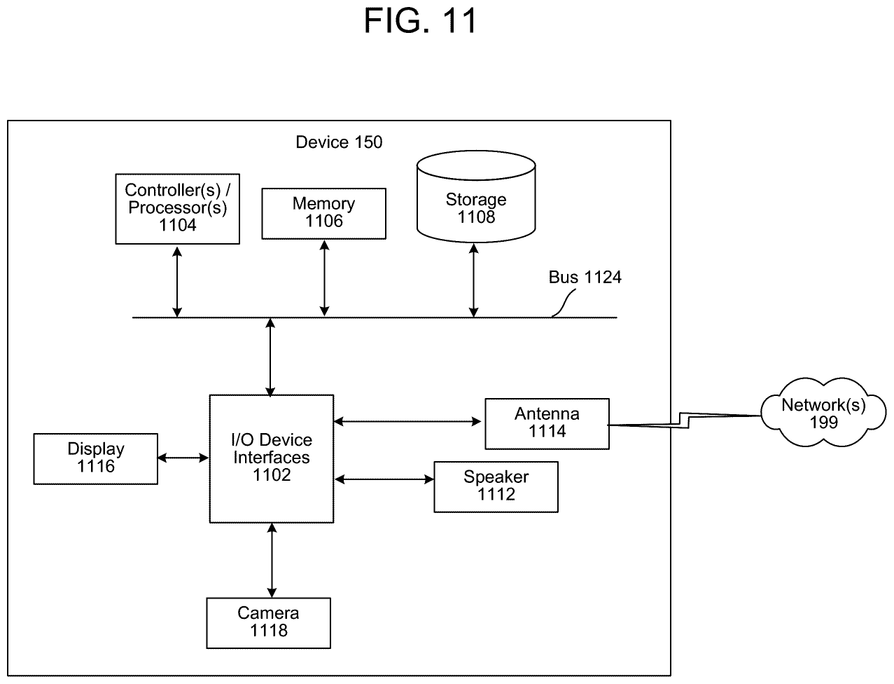

FIG. 1A is a conceptual diagram of a system 100 for analyzing an assay container 120, according to some embodiments of the present disclosure. As shown, in embodiments, the system 100 includes a reader device 130 in communication with a system(s) 105, which are in communication with a client device 150 via one or more networks 199. The reader device 130 may be in wired or wireless communication with the system(s) 105. The system(s) 105 may include one or more servers, one or more computing devices, or other types of computing systems. The system(s) 105 may include components described below in relation to FIG. 11. The client device 150 may be a computing device (e.g., a desktop, a laptop, a tablet, a smartphone, etc.) that includes or is associated with a display, among other input/output interfaces. The client device 150 may include components described below in relation to FIG. 10.

In embodiments, the reader device 130 is used to detect biological, chemical or physical components in biological samples in an assay container (e.g., the assay container 120), and can be for example and without limitation, a plate reader, a microplate reader, a microplate photometer, or the like. In embodiments, the assay container 120 includes one or more wells, where each well can hold a biological sample from a subject (e.g., human, animal, etc.) and one or more particles (e.g., identifiable beads). The particle(s) react with one or more different target entities (e.g., antigens, a pathogens, biomarkers, etc.), and in response to reacting, the particles may be configured to fluoresce. An example assay container 120 may include 96 wells (e.g., in a 8×12 matrix). Other example assay containers may include 384 wells, 1536 wells, or any suitable number of wells. The reader device 130 is configured to detect a fluorescence quantity (e.g., fluorescence intensity) associated with wells of the assay container. The reader device 130 may be configured to capture one or more images of an assay container to detect fluorescence intensity. In other embodiments, the reader device 130 may be configured to detect other fluorescence quantities, for example, absorbance, luminescence, time-resolved fluorescence, or fluorescence polarization.

A user (e.g., a lab technician, a clinician, a researcher, etc.) may prepare the assay container 120 by placing (e.g., using a pipette) biological samples to be tested and a solution containing individual particle(s) (e.g., identifiable beads) in individual wells of the assay container 120. Dye, reagent, or the like, in some embodiments, is added to the mixture of biological sample and particle solution. Thereafter, the user may cause a washer equipment to operate on the assay container 120 to remove waste (e.g., excess dye, reagent, or the like) from the assay container 120. After washing, the assay container 120 may be analyzed using the reader device 130.

In embodiments, the reader device 130 includes an image capturing device (e.g., a camera) that, in response to receiving the assay container 120 (or in response to a user input activating the reader device 130), may capture one or more images of the assay container 120. In some embodiments, the reader device 130 may capture an image of a portion (e.g., a quadrant, a half, etc.) of each well of the assay container 120. For example, the reader device 130 may capture four images of the well, each image corresponding to a quadrant of the well. In such examples, the reader device 130 may generate 96×4 images for the assay container 120. In some embodiments, the reader device 130 may capture additional images of the assay container 120.

In some embodiments, the reader device 130 includes a brightfield light source and captures brightfield images of the wells of the assay container 120 via the image capturing device. The reader device 130, in some embodiments, includes a fluorescent light source (e.g., a light emitting diode or the like) and captures fluorescent images of the assay container via the image capturing device.

In embodiments, the reader device 130 sends image data 115 to the system(s) 105, where the image data 115 includes one or more images (e.g., brightfield and/or fluorescent images) of the assay container 120. In some embodiments, the system(s) 105 sends instructions or other data to the reader device 130 to operate the reader device 130 or to cause the reader device 130 to perform an action. For example, the system(s) 105 may request the image data 115 from the reader device 130.

In some embodiments, the reader device 130 sends other data to the system(s) 105 in addition to the image data 115. Such other data may be metadata representing information related to the assay container 120, for example, an identifier (e.g., an alphanumerical value) for the assay container 120, a number of wells in the assay container 120, a time and date of when the assay container 120 was processed by the reader device 120, a user identifier for the user that operated the reader device 130, etc. In example embodiments, the other data may include data indicating the individual wells in the images. For example, the other data may include an indication of the pixels in the image that correspond to an individual well and may associate the pixel information with a well identifier (e.g., well 1).

In embodiments, the system(s) 105 are configured to process the image data 115 (and the other data) to determine whether a well corresponds to a success condition or a failure condition, and whether a well corresponding to a success condition represents that the target entity or entities is present in the sample. In embodiments, the system(s) 105 generates output data 140, representing the foregoing determined information among other things, and may send the output data 140 to the client device 150. Further details on the output data 140 are described below. In some cases, the client device 150 is operated by the user that processed the assay container 120 using the reader device 130. In some cases, the client device 150 is operated by an end-user, such as a subject (e.g., a patient), a guardian of a subject, a representative of a subject, etc. who may be interested in receiving the results of one or more samples of the assay.

Embodiments of the present disclosure use a mean/average pixel intensity value for a well to determine whether the well is a failure condition or a success condition. In wells that have no issues (i.e. a successful well), the only source of fluorescence or light intensity is the identifiable beads that are positive for specific analytes. For such wells, most of the well image will have dark pixels (e.g., very low pixel intensity values). This means that when the average pixel intensity value is calculated, wells that “pass” or succeed will have comparatively low average pixel intensity value (e.g., in a range of 50-80, inclusive of the endpoints). On the other hand, wells that “fail” will have fluorescence production from not only the identifiable beads, but also from reagents (or other waste) that are erroneously added/not removed from the well. Therefore, the average pixel intensity value for the “fail” wells will be comparatively high, and if it is higher than the threshold value, the system(s) 105 identifies the well as a failure condition.

In embodiments, the system(s) 105 is configured to perform an example process 160, illustrated in the flowchart of FIG. 1B, for analyzing the image data 115 to determine success and failure conditions for individual wells. Referring to FIGS. 1A and 1B, at a step 162 of the process 160, the system(s) 105 receives the image data 115 representing a plurality of wells of the assay container 120. At step 164, the system(s) 105 analyzes the image data 115 to determine, for a plurality of pixels corresponding to a well of the plurality of wells, a pixel intensity value. In some embodiments, the pixel intensity value for each of the plurality of wells is a mean pixel intensity value for each of the wells. As described hereinabove, the pixel intensity value for each of the plurality of wells is based at least in part on intensity values of individual pixels of the plurality of pixels corresponding to the well. In some embodiments, the pixel intensity value may be a mode, a median or other type of statistical representation of the intensity values of individual pixels of the plurality of pixels corresponding to the well. In some embodiments, the system(s) 105 may analyze one image corresponding to a portion (e.g., a quadrant) of the well, and may determine a pixel intensity value (e.g., a mean pixel intensity value) for the pixels included in the image and corresponding to the portion of the well.

At a decision step 166, the system(s) 105 determines whether the pixel intensity value for the well or portion of the well is greater than a threshold value. In some embodiments, the threshold value may be defined to detect fluorescence of a well based on waste being present in the well, for example, when the washer equipment did not remove all the waste from the well. A pixel intensity value may range from 0 to 4096 in some example embodiments. In some embodiments, the threshold value may be set to a value between 0 and 4096 (e.g., 170, 200, 1000, 2000, etc.). In some embodiments, multiple threshold values can be set to detect different failure conditions, as described below. In some embodiments, the system(s) 105 may determine whether the pixel intensity value for the portion of the well (e.g., a quadrant of the well) is greater than the threshold value.

If the pixel intensity value is greater than the threshold value, then at a step 168, the system(s) 105 generates the output data 140 indicating that the well corresponds to a failure condition. In some embodiments, the system(s) 105 may determine that the well corresponds to a failure condition if a portion of the well (e.g., a quadrant) has a pixel intensity value that is greater than the threshold value. In such cases, the system(s) 105 may determine that the portion of the well having a pixel intensity value greater than the threshold value is indicative of an overflow of reagent or other solution from another/adjacent well into the well being analyzed, wherein the overflow only affects a portion of the well. Such overflow affecting a portion of the well may result in the well being labeled as a failure condition, in some embodiments, to prevent reporting of a false positive corresponding to the well. In some embodiments, an overflow that only affects a portion of the well may be detected as a success condition depending on system configuration, and results from the remaining portion of the well may be reported (e.g., target entity is detected or not detected).

If the pixel intensity value is less than the threshold value, then at a step 170, the system(s) 105 generates the output data 140 indicating that the well corresponds to a success condition. A success condition may represent that the results of the well have not been affected by a malfunctioning component, a user error, etc.

In some embodiments, the system(s) 105 is configured to output results corresponding to wells for which a success condition was detected, and the output results may indicate whether the target entity was detected in the sample of the respective well. The system(s) 105 is configured to prevent output of results corresponding to wells for which a failure condition was detected (e.g., wells corresponding to a failure condition are filtered from reporting). Instead, the system(s) 105 may include, in the output data 140, an indication that the well failed so the user may take appropriate action (e.g., by re-testing the sample in that well). The system(s) 105 may also include, in the output data 140, a notification/alert that the sample of the well, corresponding to the failure condition, is to be re-tested. The output data 140 may be presented via the display of the client device 150. In some embodiments, the output data 140 may be presented via a message (e.g., an email message, a notification message, a text message, etc.) that the user may interact with to view the output data 140.

In some embodiments, the threshold value is determined based on historic reader data representing analysis of various assay containers in the past. The historic reader data may include images of wells of past assay containers and a performance indication corresponding to each well. The performance indication may represent whether the respective well corresponds to a failure condition (e.g., waste not being removed, solution overflow, etc.), a target detected condition, or a target undetected condition. The wells corresponding to a target detected or a target undetected condition may represent success conditions. The threshold value may be set based on a comparison of first pixel intensity values for wells for which a failure condition was identified, second pixel intensity values for wells for which a target detected condition was identified, and third pixel intensity values for wells for which a target undetected condition was identified. In some embodiments, the threshold value may be set such that intensity values that are similar to the second and third pixel intensity values may be detected as success conditions. If the threshold value is set too low, then pixels with low intensity may falsely be detected as failure conditions, when the pixels correctly represent target detected condition (e.g., the pixels are bright because particles have bound with a target entity). If the threshold value is set too high, then pixels with high intensity may falsely be detected as success conditions, when the pixels correctly represent failure conditions. Based on analyzing the historic reader data, the threshold value may be set to a value between 100 and 200 in some embodiments, inclusive of the endpoints. The threshold value may be a value between 0 and 4096 in some embodiments, inclusive of the endpoints.

The threshold value may be updated dynamically based on analyzing historic reader data as further historic reader data becomes available. For example, the threshold value may be updated on a periodic basis (e.g., every six months, every year, etc.). The threshold value may be set to a different value for different reader devices 130 based on, for example, analyzing historic reader data for the particular reader device and/or the particular washer equipment. Thus, the threshold value may be adjusted for a configuration and/or performance of specific reader device and/or washer equipment. The threshold value may be set to a different value to detect different failure conditions, or the system(s) 105 may use different threshold values to detect different failure conditions. For example, a first threshold value may be used to detect a failure condition due to a washer nozzle malfunction, a second threshold value may be used to detect a failure condition due to a user error, etc. The threshold value may be set to a different value to detect a failure condition corresponding to a different portion of the assay container 120 or a portion of the well. For example, a first threshold value may be used to detect a failure condition for a quadrant of a well, a second threshold value may be used to detect a failure condition for an entirety of a well, a third threshold value may be used to detect a failure condition for a rim of a well, a fourth threshold value may be used to detect a failure condition for a quadrant of the assay container 120, a fifth threshold value may be used to detect a failure condition for a row or column of the assay container 120, etc.

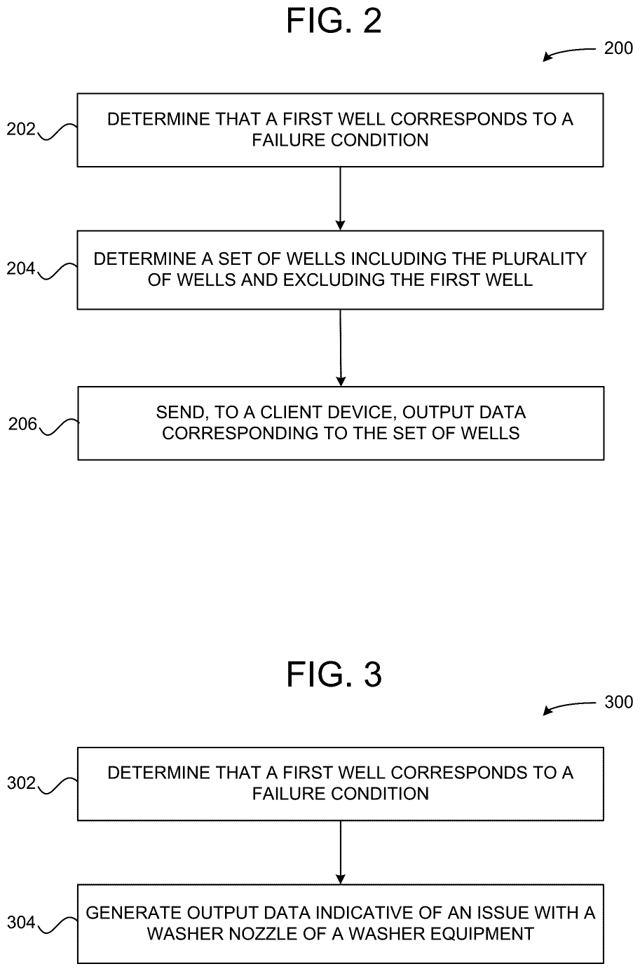

Referring to FIGS. 1A and 2, a flowchart illustrating an example process 200 for determining output data for an end user is depicted, according to some embodiments of the present disclosure. At a step 202 of the process 200, the system(s) 105 determines that a first well corresponds to a failure condition. Such a determination may be made as described herein, for example, with respect to FIGS. 1A-1B. At a step 204 of the process 200, the system(s) 105 determines a set of wells including the plurality of wells of the assay container 120 and excluding the first well (corresponding to a failure condition). In other words, the determined set of wells exclude the well(s) corresponding to the failure condition and include the other remaining wells of the assay container 120 that correspond to a success condition.

In embodiments, at a step 206 of the process 200, the system(s) 105 sends to a client device (e.g., the client device 150), output data 140 corresponding to the determined set of wells. The output data 140, in embodiments, includes the assay results of the wells that correspond to a success condition, where the assay results indicate whether the sample of a respective well includes a target based on the well fluorescing in response to the particle(s) in the respective well binding to one or more targets. The output data 140 may include a label or other type of indicator for each well of the determined set of wells that represents the assay results (e.g., a positive result indicator when one or more of the targets is detected, a negative result indicator when the one or more targets are not detected).

The output data 140, in this case, may not include results of the well(s) that correspond to a failure condition. As such, the output data 140 include results for fewer wells than all of the wells of the assay container 120 (e.g., less than 96 wells for an assay container that includes 96 wells).

In some embodiments, the output data 140 includes a different indicator (e.g., label) for the well(s) corresponding to a failure condition. For example, the output data 140 may include a failure indicator for a third well of the assay container 120, when the third well is associated with a failure condition.

The output data 140 of step 206 may be used to generate a report (e.g., an assay result report) that may be communicated to an end user, such as a doctor, a patient, etc. In some embodiments, the output data 140 is sent to the client device 150 that is operated by a laboratory technician.

Referring to FIGS. 1A and 3, a flowchart illustrating an example process 300 for determining output data 140 indicating an issue with a washer nozzle is depicted, according to some embodiments of the present disclosure. At a step 302 of the process 300, the system(s) 105 determines that a first well corresponds to a failure condition. Such determination may be made as described herein, for example, with respect to FIGS. 1A-1B.

In some embodiments, the system(s) 105 determines, based on the respective pixel intensity values for multiple wells of the assay container 120, that there is an issue with one or more individual washer nozzles of a washer equipment that is used to wash the assay container 120. As described herein, the washer equipment may include a plurality of washer nozzles, each used to wash a particular well of the assay container 120. The system(s) 105 may determine that the first well corresponds to a failure condition (as described above in relation to FIGS. 1A-1B), and may further determine whether one or more adjacent wells of the first well also correspond to a failure condition. If wells adjacent to the first well do not correspond to a failure condition (and correspond to a success condition), then the system(s) 105 determines that there is an issue with the washer nozzle that was used to wash the first well. For example, the first well may fluoresce (above the pixel intensity value) because the washer nozzle failed to remove waste from the first well during the washing process. This may occur due to an issue with the washer nozzle, such as a clog in the nozzle that may prevent appropriate flow of washing fluid/solution to ensure that the first well is washed properly. Such an issue may be resolved in some instances by unclogging/cleaning the washer nozzle.

If wells adjacent to the first well correspond to a failure condition, then the system(s) 105 may determine, in some cases, that the failure condition does not relate to an issue with a particular washer nozzle that was used to wash the first well. For example, the system(s) 105 may consider a number of adjacent wells that correspond to a failure condition, and may determine that another issue likely caused the failure (e.g., user error, overflow from the first well, etc.). As another example, the system(s) 105 may use a threshold value (which may be different than the one used in the process 160 of FIG. 1B) to determine whether the pixel intensity value of the adjacent wells exceeds the threshold value that may indicate that solution from the first well overflowed into the adjacent wells.

In some embodiments, the system(s) 105 may determine that the pixel intensity value of an adjacent well is approximately the same as the first well, and may determine that both of the first well and adjacent well correspond to a failure condition caused by an issue with a washer nozzle. For example, the system(s) 105 may determine that there is an issue with a first washer nozzle used to wash the first well and a separate issue with a second washer nozzle used to wash the adjacent well.

At a step 304 of the process 300, the system(s) 105 generate output data 140 indicative of an issue with the washer nozzle of the washer equipment. The system(s) 105 may generate the output data 140 based on determining (as described above) that a failure condition for the first well is caused by an issue with the washer nozzle used to wash the first well. In some embodiments, the output data 140 may include an identifier for the first well and an indicator representing an issue with a washer nozzle. The indicator may be text data or other visual indicator, such as an icon, an image, graphics, etc. The output data 140, in embodiments, is sent to the client device 150, which may be operated by a laboratory technician that may perform steps to resolve the issue. For example, the laboratory technician may unclog the indicated washer nozzle(s).

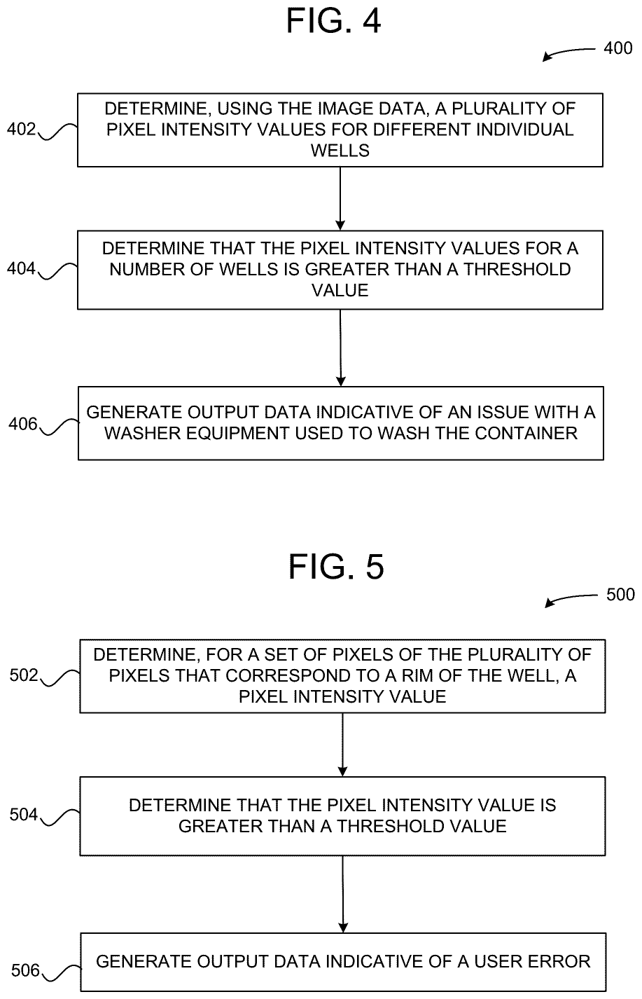

Referring to FIGS. 1A and 4, a flowchart illustrating an example process 400 for determining output data 140 indicating an issue with a washer equipment is depicted, according to some embodiments of the present disclosure. At a step 402 of the process 400, the system(s) 105 determines, using the image data 115, a plurality of pixel intensity values, each pixel intensity value associated with different individual wells of the assay container 120. Such a determination may be made as described herein, for example, with respect to FIGS. 1A-1B. At a step 404 of the process 400, the system(s) 105 determines that multiple pixel intensity values for multiple wells of a plurality of wells is greater than a threshold value. The system(s) 105 may determine that a plurality of wells of the assay container 120 correspond to a failure condition, and may determine that that is indicative of an issue with a washer equipment used to wash the assay container 120. That is, the system(s) 105 may determine that a certain number of wells (e.g., a high number, a high percentage, etc.) are failing and the cause of the identified failure conditions is likely the washer equipment, rather than an individual washer nozzle(s). In some cases, the system(s) 105 may determine that a particular part of the washer equipment has an issue based on a particular portion/region of the assay container 120 having wells corresponding to a failure condition.

At a step 406 of the process 400, the system(s) 105 generates output data 140 indicative of an issue with the washer equipment used to the wash the assay container 120. The output data 140 may be generated based on the determination at step 404. In some embodiments, the output data 140 may be sent to the client device 150, which may be operated by a laboratory technician that may perform steps to resolve the issue. For example, the laboratory technician may perform maintenance on the washer equipment.

Referring to FIGS. 1A and 5, a flowchart illustrating an example process 500 for determining output data indicating a user error is depicted, according to some embodiments of the present disclosure. At a step 502 of the process 500, the system(s) 105 determines, for a set of pixels of the plurality of pixels that correspond to a rim of the well, a pixel intensity value (e.g., a mean pixel value or the like). The system(s) 105 may identify pixels, from the image data 115, that correspond to a rim of the well or other discernable feature of the well, and determine a pixel intensity value for these pixels. For example, as described above in relation to FIGS. 1A-1B, the system(s) 105 may determine a single pixel intensity value for a plurality of pixels by determining a mean (or a mode, a median, etc.) of the individual intensity values for each of the plurality of pixels.

At a step 504 of the process 500, the system(s) 105 determines that the pixel intensity value is greater than a threshold value. The system(s) 105 may compare the determined pixel intensity value to a threshold value, which may be different than the threshold value used in the process 160 of FIG. 1B, and if the pixel intensity value is greater than the threshold value, then the system(s) 105 may determine that the well corresponds to a failure condition that is likely due to a user error rather than an equipment error. Examples of such user error include, but are not limited to, poor pipetting by a laboratory technician who prepared the assay container 120, where the technician caused solution to be applied to the rim of the well rather than or in addition to inside the well.

The system(s) 105 may determine that the well rim is fluorescing in a particular manner. For example, the system(s) 105 may determine that the center of well is not fluorescing (e.g., the pixel intensity value for the pixels of the well associated with the center does not exceed a threshold value; the center of the well corresponds to a success condition) but the well rim is fluorescing (the pixel intensity value for the pixels of the rim exceed the threshold value). As another example, the system(s) 105 may determine that the rim is fluorescing brighter than the well (e.g., the pixel intensity value for the well rim is greater than the pixel intensity value for the well; the pixel intensity value for the well rim is greater a first threshold value while the pixel intensity for the well is greater a second threshold value that is less than the first threshold value, etc.). Accordingly, the threshold value can be a configurable static value, a difference between detected pixel intensity values from different portions of the well, or a suitable combination thereof.

In embodiments, at a step 506 of the process 500, the system(s) 105 generates output data 140 indicative of a user error. The output data 140 may be generated based on the determination that the pixel intensity value for the pixels of the rim of the well is greater than the threshold value. In some embodiments, the output data 140 may be sent to the client device 150, which may be operated by a laboratory technician that may perform steps to resolve the issue. For example, the laboratory technician may be instructed to perform additional training to reduce user errors.

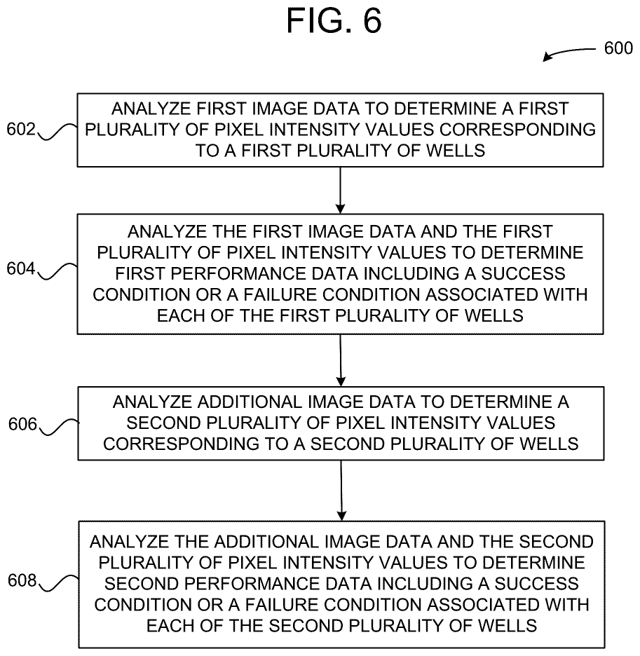

Referring to FIGS. 1A and 6, a flowchart illustrating an example process 600 for determining performance data for multiple assay containers is depicted, according to some embodiments of the present disclosure. At a step 602 of the process 600, the system(s) 105 analyzes first image data to determine a first plurality of pixel intensity values corresponding to a first plurality of wells of the assay container 120. The system(s) 105 may determine a pixel intensity value for a well as described above in relation to FIGS. 1A-1B.

At a step 604 of the process 600, the system(s) 105 analyzes the first image data and the first plurality of pixel intensity values to determine first performance data including a success condition or a failure condition associated with each of the first plurality of wells. The first performance data may correspond to a first assay container 120 and may be indicative of how many of the first plurality of wells corresponded to a failure condition and how many wells corresponded to a success condition. The first performance data may include a failure indicator or a success indicator associated with each of the plurality of wells, where the individual wells may be identified using an identifier (e.g., a well identifier). In some embodiments, the system(s) 105 may determine other information to include in the first performance data regarding the first assay container 120, for example, a percentage of wells that failed, a percentage of wells that succeeded, a number of wells that failed, a number of wells that succeeded, a particular portion/region of the assay container 120 that has failed wells, cause(s) of the failure condition, time/date that the first assay container 120 was analyzed, a user identifier for the user that prepared the first assay container 120, an identifier for the washer equipment, etc.

At a step 606 of the process 600, the system(s) 105 analyzes additional image data to determine a second plurality of pixel intensity values corresponding to a second plurality of wells of a second assay container 120. The system(s) 105 may determine a pixel intensity value for a well as described above in relation to FIGS. 1A-1B. The second assay container 120 may be analyzed using the same washer equipment and the reader device 130 as the first assay container 120.

At a step 608 of the process 600, the system(s) 105 analyzes the additional image data and the second plurality of pixel intensity values to determine second performance data including a success condition or a failure condition associated with each of the second plurality of wells. The second performance data may correspond to a second assay container 120 and may be indicative of how many of the second plurality of wells corresponded to a failure condition and how many wells corresponded to a success condition. The second performance data may include a failure indicator or a success indicator associated with each of the plurality of wells, where the individual wells may be identified using an identifier (e.g., a well identifier). The second performance data may include other information similar to the other information described above in relation to the first performance data/step 604 of the process 600.

In this manner, the system(s) 105 may perform the process 600 to determine performance data relating to analysis of assay containers. The performance data (e.g., the first and second performance data) may be used to make other determinations as described below.

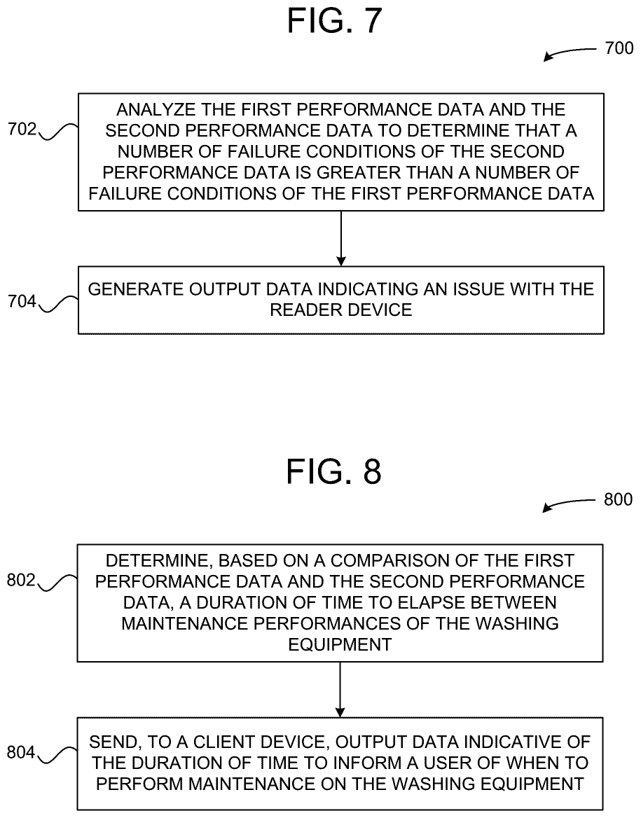

Referring to FIGS. 1A, 6, and 7, a flowchart illustrating an example process 700 for determining output data indicating an issue with a reader device is depicted, according to some embodiments of the present disclosure. At a step 702 of the process 700, the system(s) 105 analyzes the first performance data and the second performance data to determine whether a number of failure conditions of the second performance data is greater than a number of failure conditions of the first performance data. The first performance data may include a first number of wells that failed, or the system(s) 105 may determine the first number of failure conditions using the first performance data. The first performance data may also include a first time indicative of when the first assay container 120 was analyzed using the reader device 130. Similarly, the second performance data may include a second number of wells that failed, or the system(s) 105 may determine the second number of failure conditions using the second performance data. The second performance data may also include a second time indicative when the second assay container 120 was analyzed using the reader device 130.

In some cases, the system(s) 105 is configured to determine whether there is an issue with the reader device 130 based on the information included in the first performance data and the second performance data. For example, the system(s) 105, in embodiments, is configured to determine that the second time occurred after the first time (that is, the second assay container was analyzed after the first assay container), determine whether the second number of failed wells was greater than the first number of failed wells, and determine whether there is an issue with the reader device 130. In embodiments, the system(s) 105 is be configured to use the time elapsed between the first time and the second time to make the determination that there is an issue with the reader device 130. The system(s) 105 may be configured to determine whether the number of failed wells is increasing with each analysis by the reader device, which may be based on analyzing performance data for multiple assay containers.

At a step 704 of the process 700, the system(s) 105 generates output data 140 indicative of an issue with the reader device 130. The output data 140 may be generated based on the determination that the second number of wells that failed was greater than the first number of wells that failed. In some embodiments, the output data 140 may be sent to the client device 150, which may be operated by a laboratory technician who may perform steps to resolve the issue. For example, the laboratory technician may perform maintenance on the reader device 130, may update reader device 130 software, may clean a camera of the reader device 130, etc.

Referring to FIGS. 1A and 8, a flowchart illustrating an example process 800 for determining a maintenance schedule for a washer equipment is depicted, according to some embodiments of the present disclosure. At a step 802 of the process 800, the system(s) 105 determines, based on a comparison of the first performance data and the second performance data, a duration of time to elapse between maintenance performance of washing equipment. The first performance data may relate to analysis of the first assay container at a first time, and the second performance data may relate to analysis of the second assay container at a second time occurring after the first time. The system(s) 105 may compare a first number of failed wells in the first performance data to a second number of failed wells in the second performance data, may determine that the second number is greater than the first number, and may determine that maintenance on the washer equipment is to be performed. Based on the time elapsed between the first time and the second time, the system(s) 105 may determine that maintenance is to be performed after that elapsed time. For example, if the time elapsed between the first and second time is 5 days, then the system(s) 105 may determine that maintenance on the washer equipment is to be performed every 5 days or less. The system(s) 105 may determine how often maintenance is to be performed based on analyzing performance data for various assay containers and monitoring the occurrence of failure conditions, in particular due to washer nozzle or washing equipment issues. For example, the system(s) 105 may determine the first and second number of failed wells based on the wells that correspond to a failure condition due to a washer nozzle issue or a washer equipment issue. The system(s) 105 may use other information to determine how often maintenance is to be performed.

At a step 804 of the process 800, the system(s) 105 sends, to the client device 150, output data 140 indicative of the duration of time to inform a user of when to perform maintenance on the washing equipment. In some embodiments, the client device 150 may be operated by a laboratory technician that may perform maintenance steps. For example, the laboratory technician may clean/unclog one or more washer nozzles, clean or replace one or more parts of the washing equipment, etc.

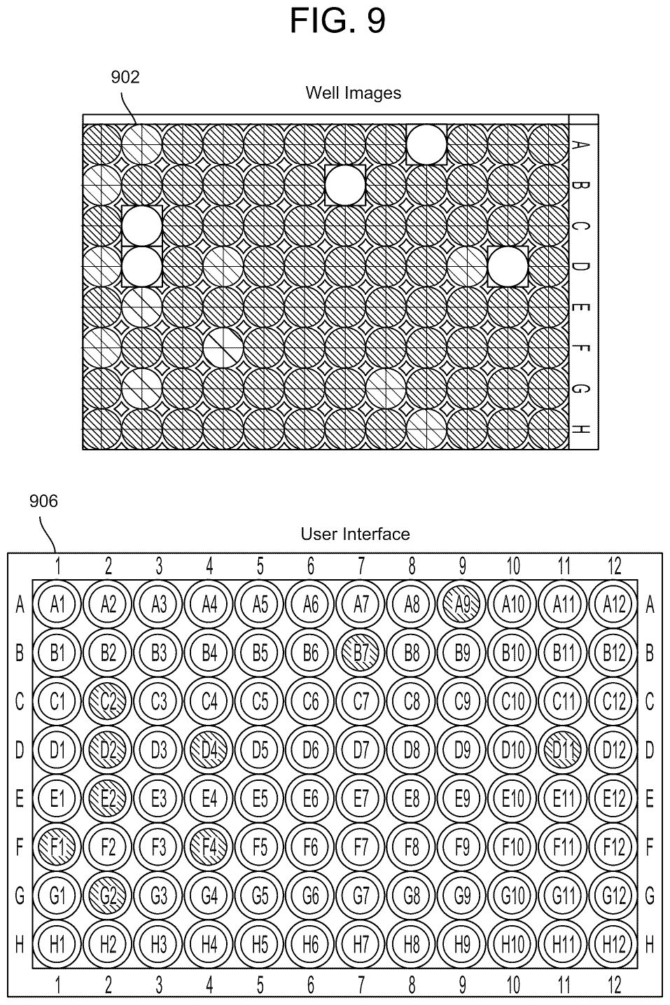

In some embodiments, output data 140 at the client device 150 may be in the form of an image of the assay container 120 or a user interface that represents the image of the assay container 120. The image representation of the assay container 120 may be determined by the system(s) 105 by modifying the image data 115, where modifications may relate to presenting visual indicators of which wells failed and which wells succeeded. Referring to FIGS. 1A and 9, an example well image 902 and an example user interface 906 of the system 100 of the present disclosure is depicted. The example user interface 906 may be displayed at the client device 150. The image 902 may be captured by a camera of the reader device 130 and may be processed by the system(s) 105 to generate the example user interface 906. As shown, a number of wells in the image 902 fluoresced brightly. Some of these wells are determined to correspond to failure conditions, and the example user interface 906 represents the failed wells using a different color (or some other different indication such as filled circles vs. empty circles) than the wells that succeeded. Conventional systems do not recognize wells associated with failure conditions, and may thus end up reporting false positives. As shown, the example user interface 906 may include row and column numbers and a well may be identified using the corresponding row and column number (e.g., [A1] or [A,1]).

FIGS. 10A-10B show example well images representing failure conditions caused for different reasons. Referring to FIG. 10A and identifying wells using row and column (e.g., [row, column]), wells [B, 7], [A, 9] and [D, 11] illustrate wells with failure conditions that is likely caused due to an issue with the individual washer nozzles used to wash those wells. Also referring to FIG. 10A, the group of wells [C, 2], [D, 2] and [E, 2] illustrate wells with failure conditions that is likely caused due to an overflow issue, where solution from one of those wells overflowed into the other wells. Referring to FIG. 10B, well [C, 1] illustrates a well with a failure condition where the well rim fluoresces and the likely cause of the failure condition is user error (e.g., error in pipetting that well).

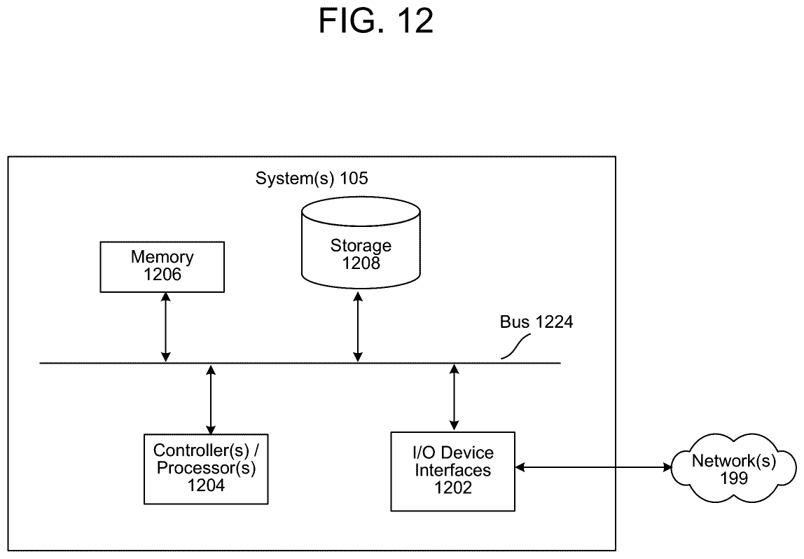

FIG. 11 is a block diagram conceptually illustrating the device 150 that may be used with the system 100. FIG. 12 is a block diagram conceptually illustrating example components of a system, such as the system(s) 105, which may be detect failure conditions of wells of an assay container using image data. A system(s) 105 may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

Multiple systems 105 may be included in the overall system of the present disclosure, such as one or more systems 105 for analyzing image data, one or more systems 105 for determining pixel intensity values, one or more systems 105 for determining a cause of the failure condition, etc. In operation, each of these systems may include computer-readable and computer-executable instructions that reside on the respective device 105, as will be discussed further below.

Each of these devices (150/105) may include one or more controllers/processors (1004/1104), which may each include a central processing unit (CPU) for processing data and computer-readable instructions, and a memory (1106/1206) for storing data and instructions of the respective device. The memories (1106/1206) may individually include volatile random access memory (RAM), non-volatile read only memory (ROM), non-volatile magnetoresistive memory (MRAM), and/or other types of memory. Each device (150/105) may also include a data storage component (1108/1208) for storing data and controller/processor-executable instructions. Each data storage component (1108/1208) may individually include one or more non-volatile storage types such as magnetic storage, optical storage, solid-state storage, etc. Each device (150/105) may also be connected to removable or external non-volatile memory and/or storage (such as a removable memory card, memory key drive, networked storage, etc.) through respective input/output device interfaces (1102/1202).

Computer instructions for operating each device (150/105) and its various components may be executed by the respective device's controller(s)/processor(s) (1104/1204), using the memory (1106/1206) as temporary “working” storage at runtime. A device's computer instructions may be stored in a non-transitory manner in non-volatile memory (1106/1206), storage (1108/1208), or an external device(s). Alternatively, some or all of the executable instructions may be embedded in hardware or firmware on the respective device in addition to or instead of software.

Each device (150/105) includes input/output device interfaces (1102/1202). A variety of components may be connected through the input/output device interfaces (1102/1202), as will be discussed further below. Additionally, each device (150/105) may include an address/data bus (1124/1224) for conveying data among components of the respective device. Each component within a device (150/105) may also be directly connected to other components in addition to (or instead of) being connected to other components across the bus (1124/1224).

Referring to FIG. 11, the device 150 may include input/output device interfaces 1102 that connect to a variety of components such as an audio output component such as a speaker 1112, a wired headset or a wireless headset (not illustrated), or other component capable of outputting audio. The device 150 may additionally include a display 1116 for displaying content. The device 150 may further include a camera 1118.

Via antenna(s) 1114, the input/output device interfaces 1102 may connect to one or more networks 199 via a wireless local area network (WLAN) (such as WiFi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (1102/1202) may also include communication components that allow data to be exchanged between devices such as different physical servers in a collection of servers or other components.

The components of the device(s) 150 or the system(s) 105 may include their own dedicated processors, memory, and/or storage. Alternatively, one or more of the components of the device(s) 150, or the system(s) 105 may utilize the I/O interfaces (1102/1202), processor(s) (1104/1204), memory (1106/1206), and/or storage (1108/1208) of the device(s) 150, or the system(s) 105, respectively.

As noted above, multiple devices may be employed in a single system. In such a multi-device system, each of the devices may include different components for performing different aspects of the system's processing. The multiple devices may include overlapping components. The components of the device 150, and the system(s) 105, as described herein, are illustrative, and may be located as a stand-alone device or may be included, in whole or in part, as a component of a larger device or system.

The concepts disclosed herein may be applied within a number of different devices and computer systems, including, for example, general-purpose computing systems, video/image processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention. All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

What is claimed is:

1. A computer-implemented method, the method comprising:
receiving image data representing a first plurality of wells, each of the first plurality of wells holding a biological sample and one or more particles configured to fluoresce in response to binding with a target entity when present in a respective well;
analyzing the image data to determine, for a first plurality of pixels corresponding to a first well of the first plurality of wells, a first pixel intensity value;
determining that the first pixel intensity value is greater than a first threshold value; and
generating first output data indicating that the first well corresponds to a failure condition in response to determining that the first pixel intensity value is greater than the first threshold value.

2. The computer-implemented method of claim 1, further comprising:
determining a set of wells from the first plurality of wells, wherein the set excludes the first well; and
sending, to a client device, second output data corresponding to the set of wells.

3. The computer-implemented method of claim 1, further comprising:
analyzing the image data to determine, for a second plurality of pixels corresponding to a second well of the first plurality of wells, a second pixel intensity value;
determining that the second pixel intensity value is less than the first threshold value; and
generating second output data indicating that the second well corresponds to a success condition in response to determining that the second pixel intensity value is less than the first threshold value.

4. The computer-implemented method of claim 3, further comprising:
sending, to a client device, third output data indicative of the one or more particles in the second well fluorescing in response to binding with the target entity.

5. The computer-implemented method of claim 1, further comprising:
generating second output data indicative of an issue with a washer nozzle of a washer equipment, wherein the washer nozzle is configured to wash the first well when the container is arranged relative to the washer equipment.

6. The computer-implemented method of claim 1, further comprising:
determining, using the image data, a plurality of pixel intensity values, wherein a second pixel intensity value of the plurality of pixel intensity values corresponds to a second well of the first plurality of wells;
determining that at least one or more of the plurality of pixel intensity values is greater than the first threshold value; and
generating second output data indicative of an issue with a washer equipment used to wash the container in response to determining that the at least one or more of the plurality of pixel intensity values is more than the first threshold value.

7. The computer-implemented method of claim 1, further comprising:
determining, for a set of pixels of the first plurality of pixels that correspond to a rim of the first well, a second pixel intensity value;
determining that the second pixel intensity value is greater than a second threshold value; and
generating second output data indicative of a user error in response to determining that the second pixel intensity value is greater than the second threshold value.

8. The computer-implemented method of claim 1, further comprising:
determining, for a first set of pixels of the first plurality of pixels that correspond to a rim of the first well, a second pixel intensity value;
determining that the second pixel intensity value is greater than the first pixel intensity value; and
generating second output data indicative of a user error in response to determining that the second pixel intensity value is greater than the first pixel intensity value.

9. The computer-implemented method of claim 1, further comprising:
analyzing the image data to determine a first plurality of pixel intensity values corresponding to the first plurality of wells;
analyzing the image data and the first plurality of pixel intensity values to determine first performance data including a success condition or a failure condition associated with each of the first plurality of wells;
receiving additional image data representing a second plurality of wells;
analyzing the additional image data to determine a second plurality of pixel intensity values corresponding to the second plurality of wells; and
analyzing the additional image data and the second plurality of pixel intensity values to determine second performance data including a success condition or a failure condition associated with each of the second plurality of wells.

10. The computer-implemented method of claim 8, wherein the image data is generated using a reader device at a first time and the additional image data is generated using the reader device at a second time occurring after the first time, and the method further comprises:
analyzing the first performance data and the second performance data to determine that a number of failure conditions occurring at the second time is greater than a number of failure conditions occurring at the first time; and
generating second output data indicating an issue with the reader device in response to determining that the number of failure conditions occurring at the second time is greater than the number of failure conditions occurring at the first time.

11. The computer-implemented method of claim 8, wherein a washing equipment is used to wash the first plurality of wells and the second plurality of wells, and the method further comprises:
determining, based on a comparison of the first performance data and the second performance data, a duration of time to elapse between maintenance performances of the washing equipment; and
sending, to a client device, second output data indicative of the duration of time to inform a user of when to perform maintenance on the washing equipment.

12. A system comprising:
at least one processor; and
at least one memory including instructions that, when executed by the at least one processor, cause the system to:
receive image data representing a first plurality of wells, each of the first plurality of wells holding a biological sample and one or more particles configured to fluoresce in response to binding with a target entity when present in a respective well;
analyze the image data to determine, for a first plurality of pixels corresponding to a first well of the first plurality of wells, a first pixel intensity value;
determine that the first pixel intensity value is more than a first threshold value; and
generate first output data indicating that the first well corresponds to a failure condition in response to determining that the first pixel intensity value is more than the first threshold value.

13. The system of claim 12, wherein the at least one memory further comprises instructions that, when executed by the at least one processor, further cause the system to:
determine a set of wells from the first plurality of wells, wherein the set excludes the first well; and
send, to a client device, second output data corresponding to the set of wells.

14. The system of claim 12, wherein the at least one memory further comprises instructions that, when executed by the at least one processor, further cause the system to:
analyze the image data to determine, for a second plurality of pixels corresponding to a second well of the first plurality of wells, a second pixel intensity value;
determine that the second pixel intensity value is less than the first threshold value; and
generate second output data indicating that the second well corresponds to a success condition in response to determining that the second pixel intensity value is less than the first threshold value.

15. The system of claim 14, wherein the at least one memory further comprises instructions that, when executed by the at least one processor, further cause the system to:
send, to a client device, third output data indicative of the one or more particles in the second well fluorescing in response to binding with the target entity.

16. The system of claim 12, wherein the at least one memory further comprises instructions that, when executed by the at least one processor, further cause the system to:
generate second output data indicative of an issue with a washer nozzle of a washer equipment, wherein the washer nozzle is configured to wash the first well when the container is arranged relative to the washer equipment.

17. The system of claim 12, wherein the at least one memory further comprises instructions that, when executed by the at least one processor, further cause the system to:
determine, using the image data, a plurality of pixel intensity values, wherein a second pixel intensity value of the plurality of pixel intensity values corresponds to a second well of the first plurality of wells;
determine that at least a number of the plurality of pixel intensity values is greater than the first threshold value; and
generate second output data indicative of an issue with a washer equipment used to wash the container in response to determining that the at least a number of the plurality of pixel intensity values is more than the first threshold value.

18. The system of claim 12, wherein the at least one memory further comprises instructions that, when executed by the at least one processor, further cause the system to:
determine, for a set of pixels of the first plurality of pixels that correspond to a rim of the first well, a second pixel intensity value;
determine that the second pixel intensity value is greater than a second threshold value; and
generate second output data indicative of a user error in response to determining that the second pixel intensity value is greater than the second threshold value.

19. The system of claim 12, wherein the at least one memory further comprises instructions that, when executed by the at least one processor, further cause the system to:
determine, for a first set of pixels of the first plurality of pixels that correspond to a rim of the first well, a second pixel intensity value;
determine that the second pixel intensity value is greater than the first pixel intensity value; and
generate second output data indicative of a user error in response to determining that the second pixel intensity value is greater than the first pixel intensity value.

20. A system comprising:
a plurality of wells, each of the plurality of wells holding a biological sample and one or more particles configured to fluoresce in response to binding with a target entity when present in a respective well;
a reader device configured to capture images of the plurality of wells; and
a computing device including:
at least one processor; and
at least one memory including instructions that, when executed by the at least one processor, cause the computing device to:
receive, from the reader device, image data representing a plurality of wells;
analyze the image data to determine, for a plurality of pixels corresponding to a first well of the plurality of wells, a pixel intensity value;
determine that the pixel intensity value is more than a threshold value; and
generate output data indicating that the first well corresponds to a failure condition in response to determining that the pixel intensity value is more than the threshold value.
